(19) United States
(12) Patent Application Publication
(10) Pub. No.: US 2026/0058452 A1
(43) Pub. Date: Feb. 26, 2026

(54) VERTICAL SUPPORT STRUCTURES FOR CONNECTING JUNCTION BOXES TO VERTICAL WALL MEMBERS

(71) Applicant: Hubbell Incorporated, Shelton, CT (US)

(72) Inventors: Krzysztof Wojciech Korcz, Shelton, CT (US); Victor Beristany, Shelton, CT (US); Krishna C. Patel, Shelton, CT (US)

(73) Assignee: Hubbell Incorporated, Shelton, CT (US)

(21) Appl. No.: 19/301,391

(22) Filed: Aug. 15, 2025

Related U.S. Application Data
(60) Provisional application No. 63/685,338, filed on Aug. 21, 2024.

(51) Int. Cl. H02G 3/08; H02G 3/12

(52) U.S. Cl. CPC H02G 3/081; H02G 3/125; H02G 3/126

(57) ABSTRACT

A vertical support structure is provided that has an elongated central leg, a foot, and a head. The foot depends from the elongated central leg and is connectable to a horizontal bottom plate. The head depends from the elongated central leg at an end opposite the foot. The head has an upper connector and a lower connector, which are positioned and configured for connection to upper and lower openings of a junction box. A center line height of the junction box is defined by a distance from the foot to a horizontal line through the head at a point between the upper and lower connectors.

### CROSS REFERENCE TO RELATED APPLICATIONS

This application claims benefit of U.S. Provisional Application 63/685,338 filed Aug. 21, 2024, the entire contents of which are incorporated herein by reference.

### BACKGROUND

### 1. Field of the Invention

The present disclosure is related to junction boxes supports. More particularly, the present disclosure is related to vertical support structures that connect junction boxes to vertical wall members.

### 2. Description of Related Art

Junction boxes and conduits are used to route and protect electrical and/or communication wiring. The junction boxes are traditionally mounted to a vertical wall member to resist movement. In the example of new construction, the junction boxes are mounted directly to the vertical wall members such as, but not limited to, wall studs.

When the studs are wooden, the junction boxes can be secured directly to the studs using nails or screws to provide a secure and firm connection. Furthermore, when junction boxes are needed in a location between two wooden studs, cross studs and/or cripples can be installed to provide a member to which the junction box can be nailed or screwed.

When the studs are metallic, the junction boxes can be secured directly to the studs using screws or other connection systems. Furthermore, when junction boxes are needed in a location between two metallic studs, a sliding bracket can be installed to provide a cross support to which the junction box can be secured.

Exemplary connection systems that secure junction boxes to metal studs, side supports, and/or sliding brackets are commercially available under the tradename Ultimate G Series and described in detail in Applicant's own U.S. application Ser. Nos. 18/168,990, 18/168,996, 18/168,998, and 18/240,977, the entire contents of all which are incorporated herein by reference.

It has been determined by the present disclosure that there is a continuing need for vertical support structures to connect junction boxes to vertical wall members, where such vertical support structures are easy to manufacture and/or install.

### SUMMARY

A vertical support structure is provided that has an elongated central leg, a foot, and a head. The foot depends from the elongated central leg and is connectable to a horizontal bottom plate. The head depends from the elongated central leg at an end opposite the foot. The head has an upper connector and a lower connector, which are positioned and configured for connection to upper and lower openings of a junction box. A center line height of the junction box is defined by a distance from the foot to a horizontal line through the head at a point between the upper and lower connectors.

In some embodiments either alone or together with any one or more of the aforementioned and/or after-mentioned embodiments, the point is equidistant between the upper and lower connectors.

In some embodiments either alone or together with any one or more of the aforementioned and/or after-mentioned embodiments, at least one of the upper and lower connectors is a bendable tab.

In some embodiments either alone or together with any one or more of the aforementioned and/or after-mentioned embodiments, the upper and lower connectors are upper and lower bendable tabs, respectively.

In some embodiments either alone or together with any one or more of the aforementioned and/or after-mentioned embodiments, the head is connectable to the upper and lower openings on a left side of the junction box or to the upper and lower openings on a right side of the junction box.

In some embodiments either alone or together with any one or more of the aforementioned and/or after-mentioned embodiments, the head has a narrowed region between the upper and lower connectors.

In some embodiments either alone or together with any one or more of the aforementioned and/or after-mentioned embodiments, the narrowed region provides clearance so that the head is connectable to left or right sides of the junction box when a side support is connected to the junction box.

In some embodiments either alone or together with any one or more of the aforementioned and/or after-mentioned embodiments, the head has a clearance region between the lower connector and the elongated central leg.

In some embodiments either alone or together with any one or more of the aforementioned and/or after-mentioned embodiments, the clearance region provides clearance so that the head is connectable to left or right sides of the junction box when a cross brace is connected to the junction box.

In some embodiments either alone or together with any one or more of the aforementioned and/or after-mentioned embodiments, the foot has a first region angled with respect to a second region, the second region depending from the leg.

In some embodiments either alone or together with any one or more of the aforementioned and/or after-mentioned embodiments, the foot is connectable to the horizontal bottom plate with the first region under the horizontal bottom plate and the second region connected to an outside surface of the horizontal bottom plate.

In some embodiments either alone or together with any one or more of the aforementioned and/or after-mentioned embodiments, the foot is connectable to the horizontal bottom plate with the first region on an inside surface of the horizontal bottom plate and the second region connected to an inside surface of the horizontal bottom plate.

In some embodiments either alone or together with any one or more of the aforementioned and/or after-mentioned embodiments, the foot further includes a third portion depending from the second portion, wherein the foot is connectable to the horizontal bottom plate with the third region on an outside surface of the horizontal bottom plate.

In some embodiments either alone or together with any one or more of the aforementioned and/or after-mentioned embodiments, the elongated central leg has a central region with an arm extending from opposite edges thereof and a rib defined in the central region.

In some embodiments either alone or together with any one or more of the aforementioned and/or after-mentioned embodiments, the vertical support structure further includes an adjuster configured to adjust the distance from the foot to the horizontal line.

In some embodiments either alone or together with any one or more of the aforementioned and/or after-mentioned embodiments, the elongated central leg has a first leg portion having the head and a second leg portion having the foot, the adjuster connecting the first and second leg portions to one another.

In some embodiments either alone or together with any one or more of the aforementioned and/or after-mentioned embodiments, the first and second leg portions each have a central region with an arm extending from opposite edges thereof and a rib defined in the central region.

In some embodiments either alone or together with any one or more of the aforementioned and/or after-mentioned embodiments, the adjuster includes a plurality of discrete positions defining the center line height at a plurality of different heights.

In some embodiments either alone or together with any one or more of the aforementioned and/or after-mentioned embodiments, the adjuster includes, on the first leg portion, a set of protrusions extending therefrom and a threaded opening between the set of protrusions, and, on the second leg portion at each of the plurality of discrete positions, a set of indentations with a keyhole opening between the set of indentations.

The above-described and other features and advantages of the present disclosure will be appreciated and understood by those skilled in the art from the following detailed description, drawings, and appended claims.

### DESCRIPTION OF THE DRAWINGS

FIG. 1 is a front view of an exemplary embodiment of a vertical support structure according to the present disclosure;

FIG. 2 is a side view of the vertical support structure of FIG. 1;

FIG. 3 is a front view of the vertical support structure of FIG. 1 with an adjuster;

FIG. 4 is a side view of the vertical support structure of FIG. 3;

FIG. 5 is a perspective view of the vertical support structure according to the present disclosure connected to a horizontal bottom plate;

FIGS. 6-7 are perspective views of the portions of vertical support structure of FIG. 3 prior to assembly;

FIG. 8 is a sectional view taken at line 8-8 of FIGS. 1 and 3;

FIG. 9 is a sectional view taken at line 9-9 of FIG. 3;

FIG. 10 is a perspective view of exemplary embodiments of junction boxes, center brackets, and side supports that find use with the vertical support structure of the present disclosure;

FIGS. 11-12 are perspective views of the vertical support structure before and after connection to a junction box; and

FIGS. 13-22 are perspective views of the vertical support structure of the present disclosure in use with various combinations of metal studs, junction boxes, center brackets, and side supports.

### DETAILED DESCRIPTION

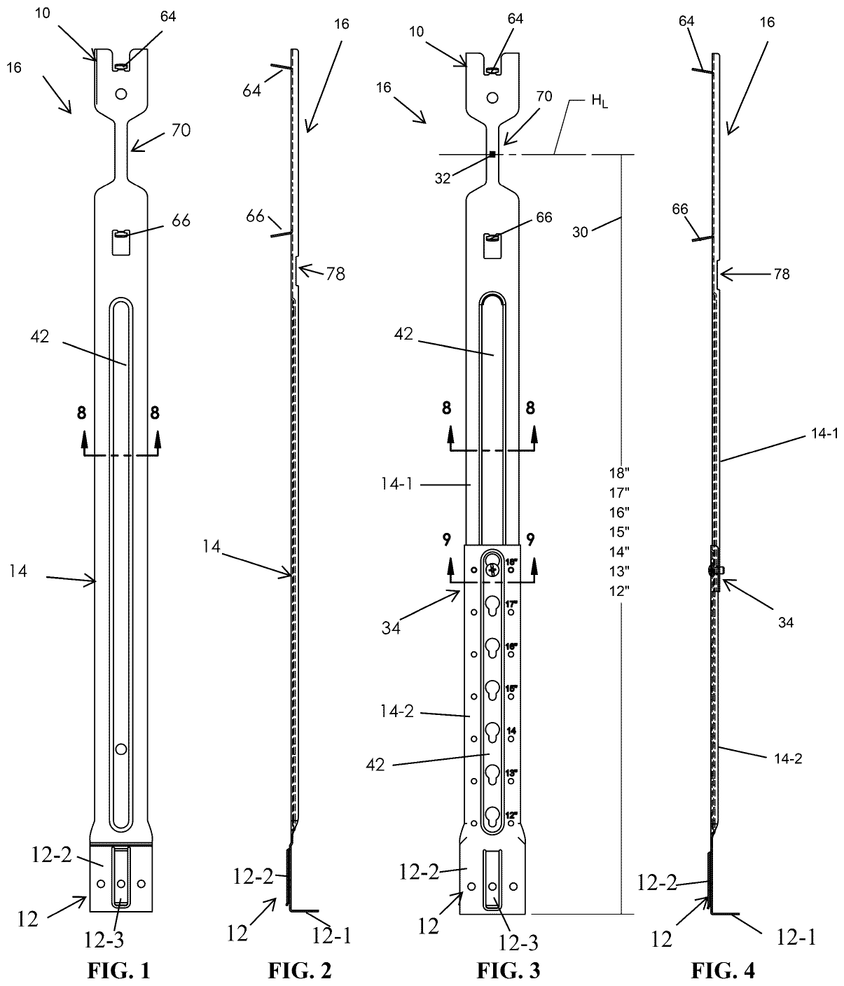

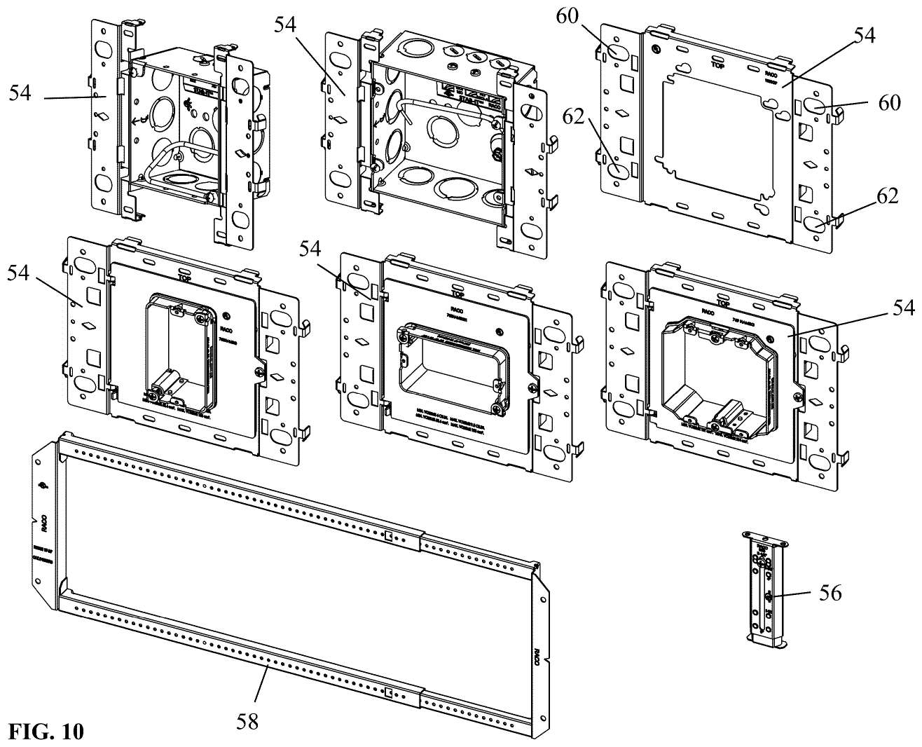

Referring to the drawings and in particular to FIGS. 1-4, an exemplary embodiment of a vertical support structure according to the present disclosure is shown and is referred to by reference number 10. Advantageously, structure 10 is configured for use with various combinations of metal studs, junction boxes, center brackets, and side supports in an easy to use and repeatable manner. Moreover, structure 10 is easy to manufacture and uses as little material as possible to reduce costs, while providing a universal ability to connect with various junction boxes and supports to add the desired rigidity to installed solutions.

Structure 10 includes a foot 12, an elongated central leg 14, and a head 16.

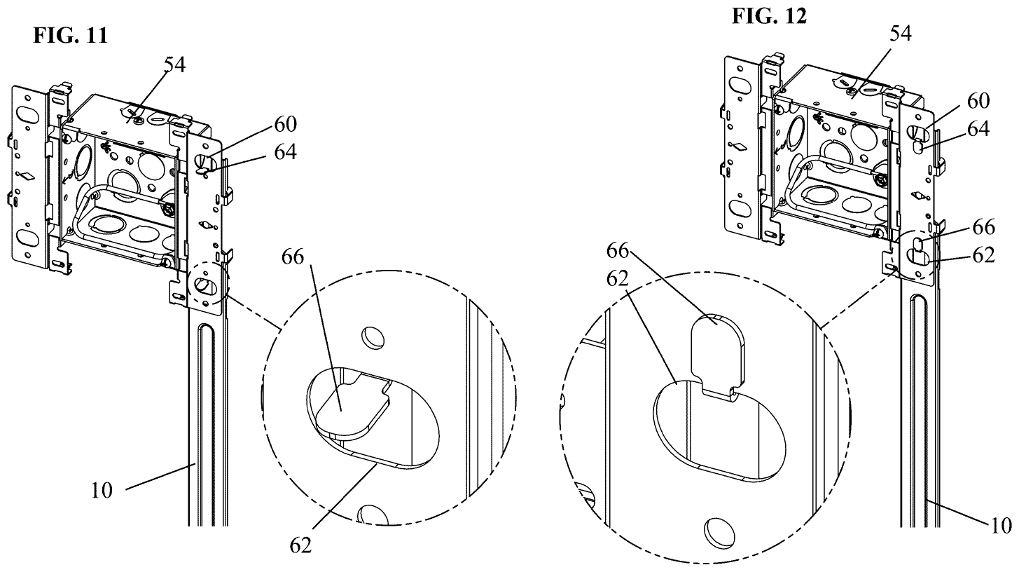

Foot 12 has a first region 12-1 angled with respect to a second region 12-2. In the embodiment shown in FIG. 5, the horizontal support structure is shown as a horizontal bottom plate 20 secured to vertical wall supports 22 (“studs”).

Foot 12 can be connected to plate 20 with first region 12-1 under the plate and second region 12-2 on an outer surface 24 of the plate as shown in the lefthand side of FIG. 5. Alternatively, foot 12 can be connected to plate 20 with first region 12-1 on a top surface 26 of the plate and second region 12-2 on an inner surface 28 of the plate as shown in the righthand side of FIG. 5. In the illustrated embodiment, foot 12 is configured for connection to plate 20 in both the outer and inner positions to provide the user flexibility in how structure 10 is installed in prebuilt wall structures. The connection of foot 12 and base plate 22 can be made by any desired mechanical connection such as, but not limited to, a self-threading fastener.

In some embodiments, second region 12-2 includes a third region 12-3 depending from the second region. Here, foot 12 can be connected to plate 20 with first region 12-1 on a top surface 26 of the plate, second region 12-2 on an inner surface 28 of the plate, and third region 12-3 on outer surface 24 of the plate as shown in the righthand side of FIG. 5. In this manner, the self-threading fastener that connects structure 10 and base plate 22 can pass through third region 12-3 first and use outer surface 24 as backing to push against, which can simplify the threaded connection to the base plate.

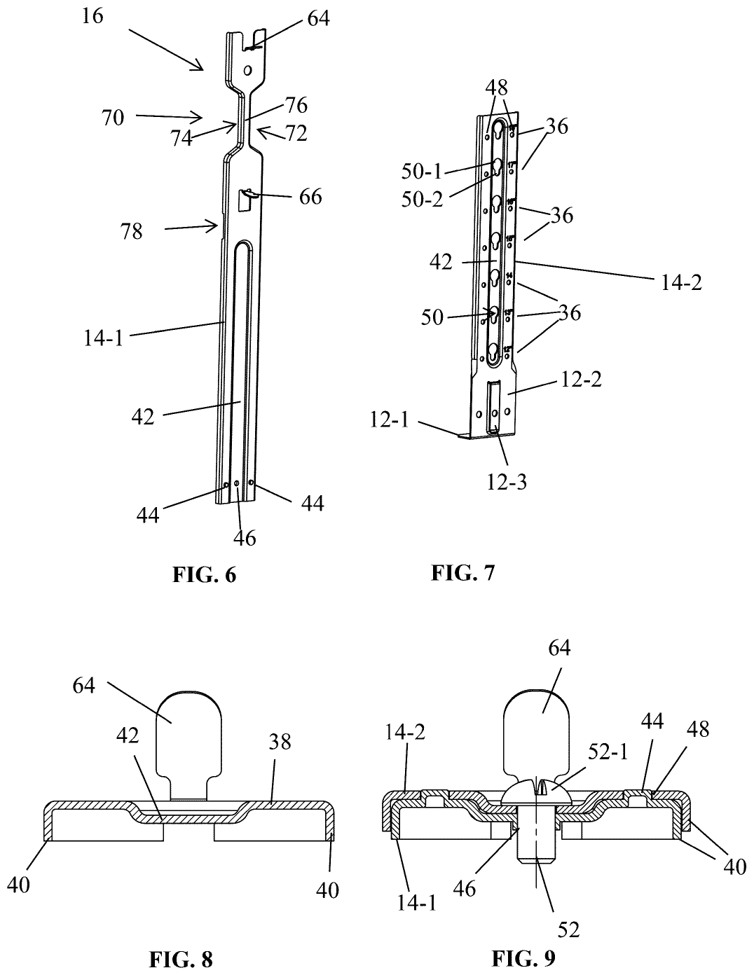

Once installed, structure 10 defines a distance from foot 12 to a horizontal line (H_{L}) that passes through a center of a connected junction box (not shown), known as the center line height 30 as shown in FIG. 3. Center line height 30 is defined as the distance from foot 12 to a point 32 on a horizontal line (H_{L}) through head 16.

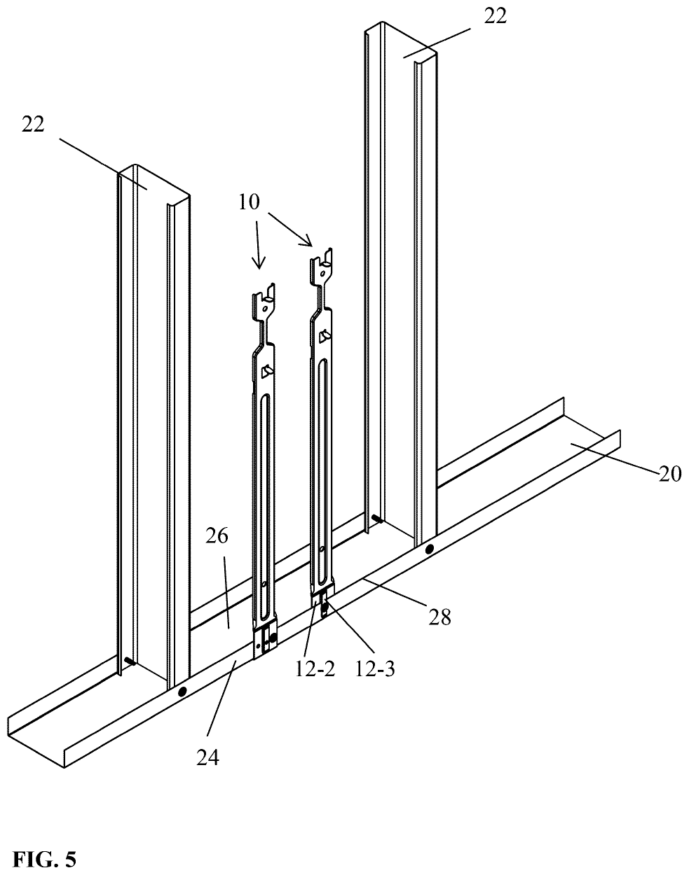

In the embodiment of FIGS. 1-2, structure 10 is configured to provide a fixed or set center line height 30 such as, for example, 18 inches (45.75 cm).

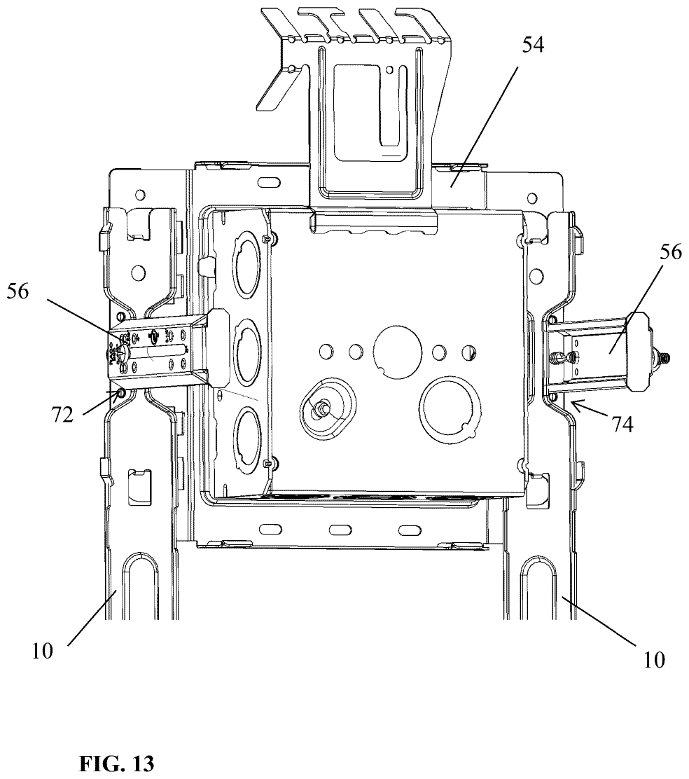

In the embodiment of FIGS. 3-4 and 6-9, structure 10 can include an adjuster 34 configured to adjust an overall length of the structure to fit any desired center line height 30 of the connected junction box (not shown).

In the embodiment of FIGS. 3-4 and 6-9, structure 10 includes adjuster 34 positioned in leg 14. More particularly, leg 14 includes a first portion 14-1 engaged with a second portion 14-2 at adjuster 34. While structure 10 is shown by way of example only having adjuster 34 positioned in leg 14, it is contemplated by the present disclosure for structure 10 to have adjuster 34 positioned in foot 12, between the foot and leg 14, in the leg, between the leg and head 16, in the head, and any combinations thereof.

In some embodiments, adjuster 34 can be configured so that structure 10 establishes center line 30 at a desired height between, for example, 12 inches (30.5 centimeters or cm) to 18 inches (45.75 cm).

In the illustrated embodiment, adjuster 34 has seven discrete positions 36 with an incremental distance of 1 inch (2.54 cm) between each discrete position. Of course, it is contemplated by the present disclosure for structure 10 to have more or less than seven discrete positions 36. Moreover, it is contemplated by the present disclosure for adjuster 34 to provide structure 10 with an unlimited number of positions, namely lacking any discrete positions.

In some embodiments, leg 14, and in particular first and second portions 14-1, 14-2, can include a central region 38 with arms 40 extending at angles thereto. In some embodiments, arms 40 extend into head 16. Arms 40 add rigidity to structure 10 in bending and compression.

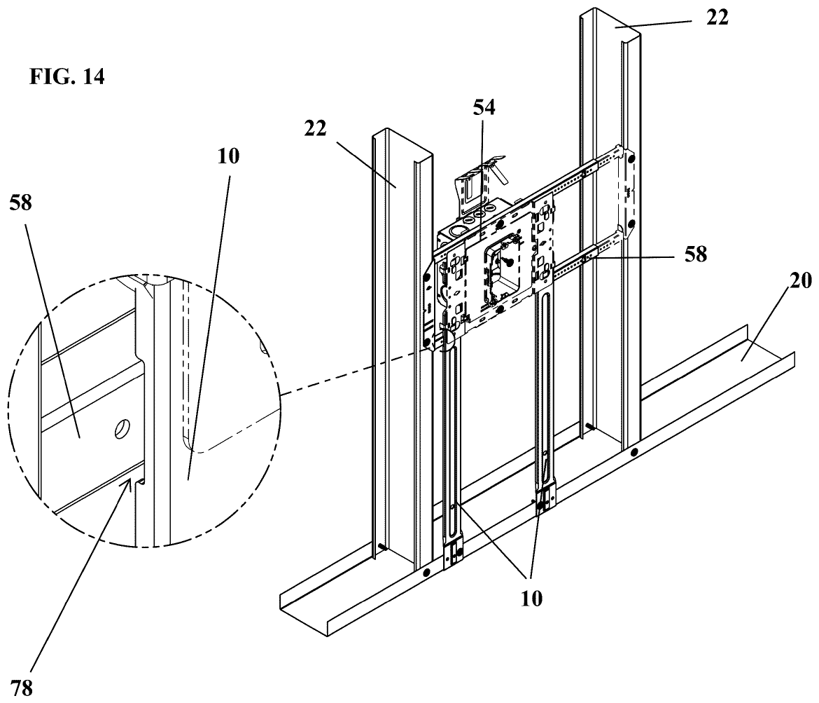

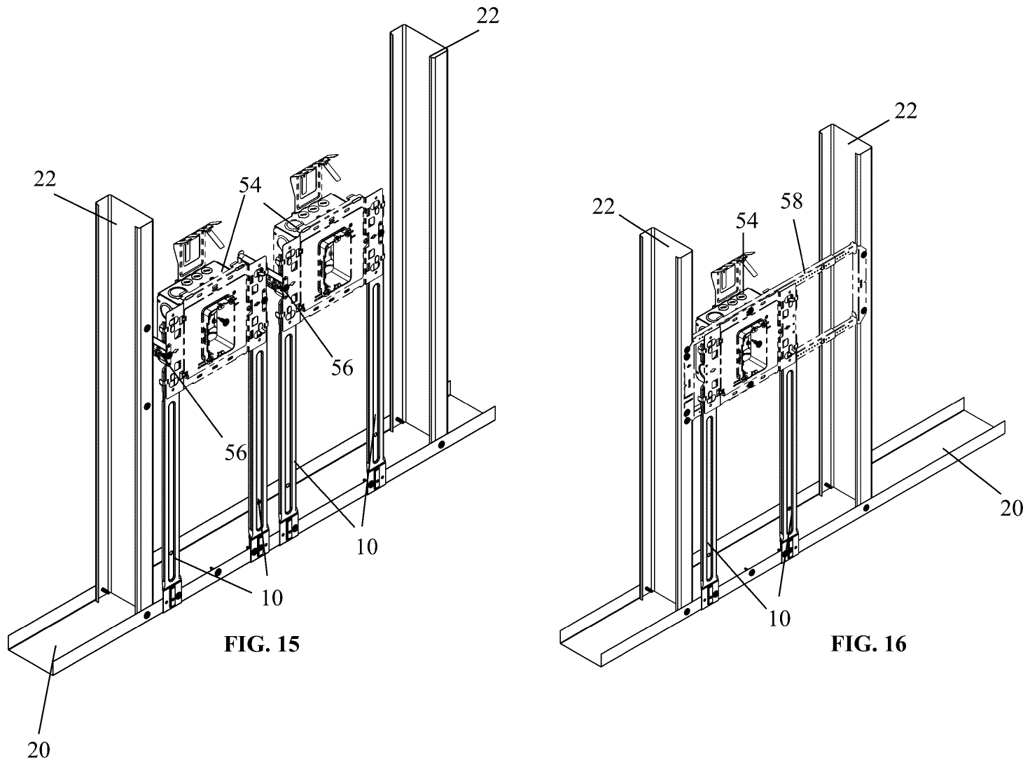

Portions 14-1, 14-2 are sized and configured so that the second portion is received in first portion 14-1 as shown in FIGS. 8 and 9.

In some embodiments, portions 14-1, 14-2 can include a rib 42 defined in central region 38. Rib 42 is an elongated impression in the central region that adds rigidity to structure 10 in bending and compression. Portions 14-1, 14-2 are sized and configured so that first portion 14-1 is received in second portion 14-2 as shown in FIGS. 8 and 9.

Adjuster 34 includes a set of protrusions 44 extending from central region of first portion 14-1 and a threaded opening 46 between the protrusions. Adjuster 34 further includes, at each discrete position 36, a set of indentations 48 in central region of second portion 14-2 with a keyhole opening 50 between the indentations. In the illustrated embodiment, indentations 48 are illustrated as through holes. Adjuster 34 further includes a threaded fastener 52 in threaded opening 46 of first portion 14-1.

During assembly, first portion 14-1 is inserted into second portion 14-2 so that a head 52-1 of fastener 52 is received through a larger region 50-1 of keyhole opening 50 at the desired discrete position 36, and then moved so that the head is received in a smaller region 50-2 of the keyhole opening. In this position, protrusions 44 of first portion 14-1 are received in indentations 48 of second portion 14-2—then fastener 52 is tightened to secure the first and second portions to one another in discrete position 36.

In embodiments that lack discrete position 36, first member 14-1 is free from protrusions 44 while second member 14-2 is free from indentations 48. Here, keyhole opening 50 is replaced with a single larger region 50-1 and a smaller region 50-2 in the form of an elongated slot. During assembly, second portion 14-2 is inserted into first portion 14-2 so that a head 52-1 of fastener 52 is received through larger region 50-1 and then moved so that the head is received in a smaller region 50-2. In this position, portions 14-1, 14-2 can be slid with respect to one another to the desired center line 30 then fastener 52 is tightened to secure the first and second portions to one another.

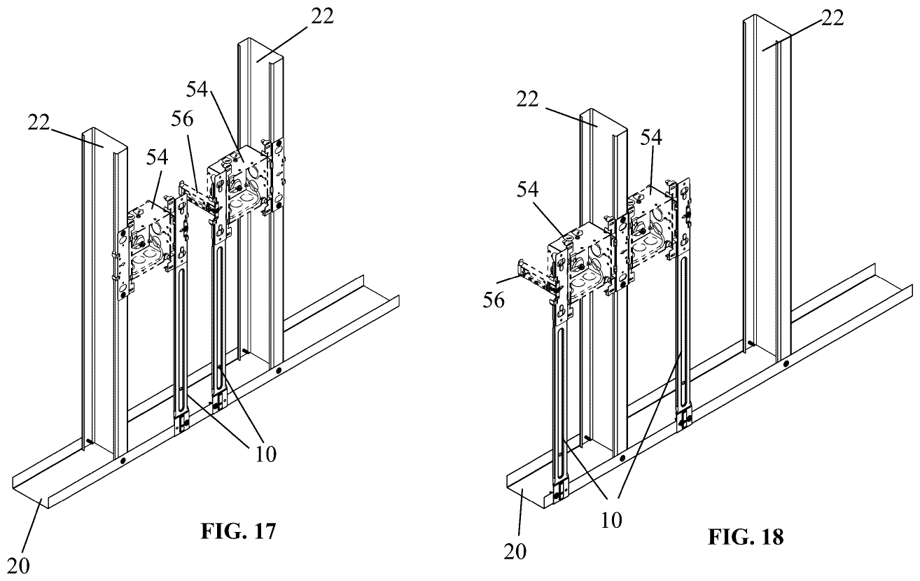

Exemplary junction boxes 54, side supports 56, and center supports 58 for use with structure 10 are shown in FIG. 10. Advantageously, head 16 is configured to allow structure 10 to find use with a number of different junction boxes 54, side supports 56, center supports 58, and combinations thereof.

In the embodiments of junction boxes 54 shown in FIG. 10, each box includes, on the lefthand side and the righthand side, an upper mounting opening 60 and a lower mounting opening 62.

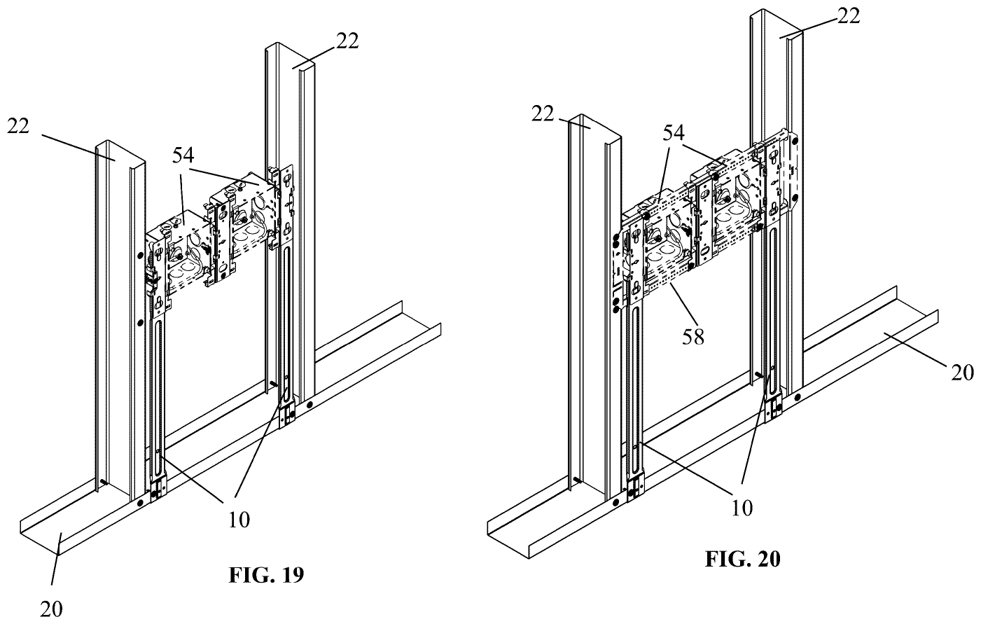

Structure 10 provides an easy-to-use connection system for junction boxes 54. In some embodiments, head 16 includes an upper bendable tab 64 and a lower bendable tab 66. Tabs 64, 66 are positioned and sized for insertion into openings 60, 62 as shown in FIG. 11.

As discussed above, structure 10 defines a center line height 30 of the junction box that is connected thereto. Here, point 32 is positioned between tabs 64, 66 to set horizontal line (H_{L}) through head 16. In the illustrated embodiment, point 32 is equidistant to tabs 64, 66. Of course, it is contemplated by the present disclosure for point 32 to be closer to tab 64 or closer to tab 66 as desired.

Once tabs 64, 66 have been received in openings 60, 62, the tabs can be bent over to secure junction box 54 to structure 10 as shown in FIG. 12. In this manner, structure 10 can be connected to either the lefthand side of junction box 54, to the righthand side of the junction box, or to both the lefthand and righthand sides of the junction box, providing a universality of connection.

It should be recognized that the connection of structure 10 at head 16 to junction box 54 is described above as requiring the head to have bendable tabs 64, 66. Of course, it should be recognized that head 16 can have any desired mechanical connector to secure to openings 60, 62. For example, in some embodiments one or both of tabs 64, 66 can be threaded openings such that a screw is used to connect structure 10 to junction box 54 at openings 60, 62. In other embodiments, one of tabs 64, 66 can be pre-bent parallel to head 16 to define a gap (not shown) between the bent tab and the head. In this manner, the pre-bent tab can be received in its respective opening 60, 62 of junction box 54 to further simplify assembly.

Additionally, it has been determined by the present disclosure that, when mounting a plurality of junction boxes 54 in a prefabricated set of wall studs 22, it is required that the center of all of these junction boxes be at the same center line 30 distance from the floor. In the prior art, it is known that some installers use a special fixture gage or jig that allows them to establish the center line 30 as they install each junction box 54.

Advantageously, structure 10—when secured to junction box 54—combines the functionality of the prior art fixture gage with a vertical support that increases the rigidity of the installation. Simply, the installer can either select structure 10 having the desired length to set center line 30 or can adjust structure 10, using adjuster 34, to the desired length to set the center line 30 and connect the structures to the junction boxes 54. In this manner, the sub-assembly of structure 10 and junction box 54 serves to set the height of center line 30, while providing a vertical support to the junction box.

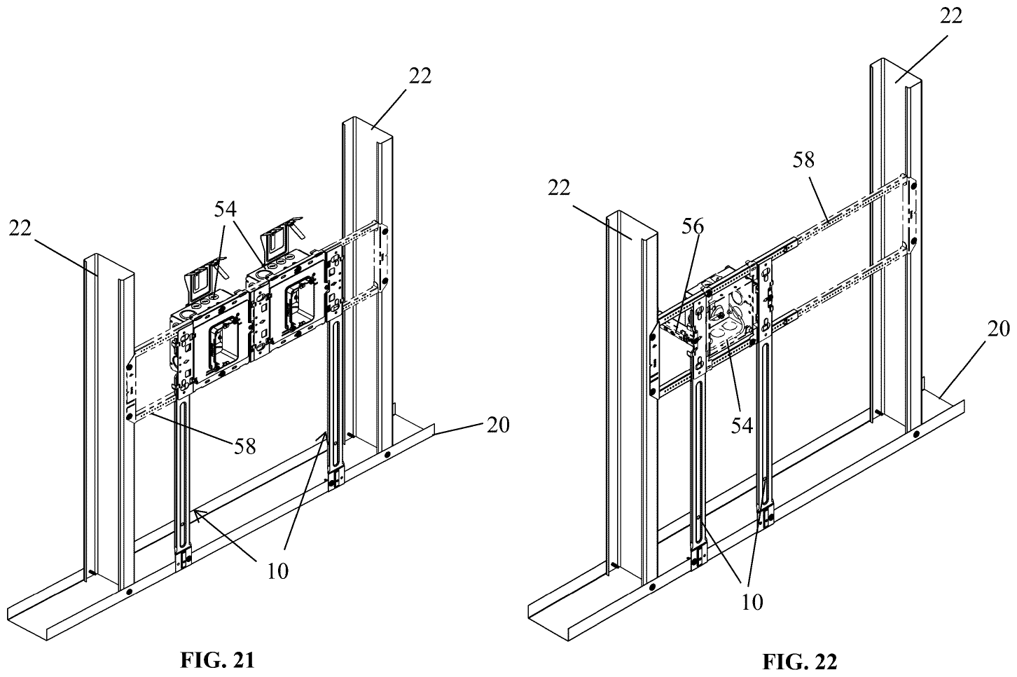

Structure 10 also provides an easy-to-use connection system for side supports 56. In some embodiments, head 16 includes a narrowed region 70. Narrowed region 70 is a reduced width region of structure 10 providing clearance areas 72, 74 to either side of the central area 76. In this manner, head 16 is sized and positioned to provide clearance so that when side support 56 is secured to junction box 54 the head 16, due to areas 72, 74, does not contact or interfere with the side support as shown in FIG. 13.

In this manner, structure 10 can be connected to either the lefthand side of junction box 54 having side support 56, to the righthand side of the junction box having the side support, or to both the lefthand and righthand sides of the junction box having the side support, providing a universality of connection.

Structure 10 also provides an easy-to-use connection system for center supports 58. In some embodiments, head 16 includes a clearance region 78. Clearance region 78 is a reduced thickness region of structure 10 providing clearance for center support 58. In embodiments where structure 10 includes arms 40 in head 16, clearance region 78 can be formed by eliminating the arms in the area where center support 58 interacts with structure 10.

Head 16 is sized and positioned to provide clearance so that when center support 58 is secured to junction box 54 the head 16, due to clearance region 78, does not contact or interfere with the side support as shown in FIG. 14.

In this manner, structure 10 can be connected to either the lefthand side of junction box 54 having center support 58, to the righthand side of the junction box having the center support, or to both the lefthand and righthand sides of the junction box having the center support, providing a universality of connection.

Structure 10 is, in some embodiments, formed of metal such as, but not limited to, steel, aluminum, iron, and alloys thereof. Of course, it is contemplated by the present disclosure for structure to be formed of plastic or other molded polymers.

When structure 10 is made of steel, the steel can be coated or galvanized or uncoated and can be hot or cold rolled. The steel of structure 10 can be made of any desired gauge or thickness, with preferably between 30 gauge to 8 gauge, with more preferably from between 24 gauge to 14 gauge, with between 18 gauge to 20 gauge being most preferred, and any subranges therebetween.

In embodiments were structure 10 has a fixed height, the structure can be formed of a single piece of stamped steel that is bent to provide second region 12-2, arms 40, rib 42, threaded opening 46, bendable tabs 64, 66, narrowed region 70, and clearance region 78. Of course, it is further contemplated by the present disclosure for foot 12 to be separately formed and secured to leg 14 as shown and/or for head 16 to be to be separately formed and secured to leg 14.

In embodiments where structure 10 has adjuster 34, the structure can be formed of a stamped steel sections that are bent to provide foot 12, leg portions 14-1, 14-2, and head 16, respectively.

Accordingly, structure 10 provides a simple to manufacture vertical support and easy to use solution that provides a universal connection to junction boxes 54 with horizontal bottom plates 20, studs 22, side supports 56, center supports 58, and any combinations thereof.

Exemplary uses of structure 10 are shown and described with reference to FIGS. 15-21.

FIG. 15 illustrates two structures 10 securing junction box 54 to the outside of horizontal bottom plate 20 in a position between studs 22. Here, structures 10 are shown having a side support 56 at each side of junction box 54.

FIG. 16 illustrates two structures 10 securing junction box 54 to the outside of horizontal bottom plate 20 in a position between studs 22. Here, structure 10 is used in combination with center support 58, eliminating the need for the side supports 56 of FIG. 15.

FIG. 17 illustrates one structure 10 secured to one side of junction box 54, while stud 22 is secured to the opposite side of the junction box. Structure 10 is shown secured to the outside of horizontal bottom plate 20. Here, structure 10 is used in combination with side support 56 at the side of junction box 54 having the structure. Advantageously, structure 10 can be used on either the left or the right side of stud 22 as shown.

FIG. 18, similar to FIG. 17, illustrates one structure 10 secured to one side of junction box 54, while stud 22 is secured to the opposite side of the junction box. Structure 10 is shown secured to the outside of horizontal bottom plate 20. Here, structure 10 is used in combination with side support 56 at the side of junction box 54 having the structure with stud 22 between the two junction boxes.

FIG. 19 illustrates two structures 10 securing two junction boxes 54 to the outside of horizontal bottom plate 20 in a position between studs 22. FIGS. 20 and 21 illustrate two structures 10 securing two junction boxes 54 to the outside of horizontal bottom plate 20 in a position between studs 22 together with center support 58. FIG. 22 illustrate two structures 10 securing a junction box 54 to horizontal bottom plate 20 between studs 22 with a combination of both side support 56 and center support 58.

Accordingly, structure 10 advantageously provides vertical support to assist the user in installing one or more junction boxes 54 alone or together with one or more of various combinations of base plates 20, studs 22, side supports 56, and center brackets 58.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure is not limited to the particular embodiment(s) disclosed as the best mode contemplated, but that the disclosure will include all embodiments falling within the scope of the appended claims.

PARTS LIST

vertical support structure 10
foot 12
first region 12-1 of the foot
second region 12-2 of the foot
third region 12-3 of the foot
elongated central leg 14
first leg portion 14-1
second leg portion 14-2
head 16
horizontal bottom plate 20
stud 22
outer surface 24 of the plate
top surface 26 of the plate
inner surface 28 of the plate
center line height 30
point 32
horizontal line HL
adjuster 34
discrete positions 36
central region 38
arms 40
rib 42
set of protrusions 44
threaded opening 46
indentations 48
keyhole opening 50
larger region 50-1
smaller region 50-2
threaded fastener 52
head 52-1
junction boxes 54
side supports 56
center supports 58
upper mounting opening 60
lower mounting opening 62
upper bendable tab 64
lower bendable tab 66
narrowed region 70
clearance areas 72, 74
central area 76
clearance region 78

What is claimed is:

1. A vertical support structure, comprising
an elongated central leg;
a foot depending from the elongated central leg, the foot being connectable to a horizontal bottom plate;
a head depending from the elongated central leg at an end opposite the foot, the head having an upper connector and a lower connector, the upper and lower connectors being positioned and configured for connection to upper and lower openings of a junction box; and
a center line height of the junction box is defined by a distance from the foot to a horizontal line through the head at a point between the upper and lower connectors.

2. The vertical support structure of claim 1, wherein the point is equidistant between the upper and lower connectors.

3. The vertical support structure of claim 1, wherein at least one of the upper and lower connectors is a bendable tab.

4. The vertical support structure of claim 1, wherein the upper and lower connectors are upper and lower bendable tabs, respectively.

5. The vertical support structure of claim 1, wherein the head is connectable to the upper and lower openings on a left side of the junction box or to the upper and lower openings on a right side of the junction box.

6. The vertical support structure of claim 1, wherein the head has a narrowed region between the upper and lower connectors.

7. The vertical support structure of claim 6, wherein the narrowed region provides clearance so that the head is connectable to left or right sides of the junction box when a side support is connected to the junction box.

8. The vertical support structure of claim 1, wherein the head has a clearance region between the lower connector and the elongated central leg.

9. The vertical support structure of claim 8, wherein the clearance region provides clearance so that the head is connectable to left or right sides of the junction box when a cross brace is connected to the junction box.

10. The vertical support structure of claim 1, wherein the foot comprises a first region angled with respect to a second region, the second region depending from the leg.

11. The vertical support structure of claim 10, wherein the foot is connectable to the horizontal bottom plate with the first region under the horizontal bottom plate and the second region connected to an outside surface of the horizontal bottom plate.

12. The vertical support structure of claim 10, wherein the foot is connectable to the horizontal bottom plate with the first region on an inside surface of the horizontal bottom plate and the second region connected to an inside surface of the horizontal bottom plate.

13. The vertical support structure of claim 12, wherein the foot further comprises a third portion depending from the second portion, wherein the foot is connectable to the horizontal bottom plate with the third region on an outside surface of the horizontal bottom plate.

14. The vertical support structure of claim 1, wherein the elongated central leg has a central region with an arm extending from opposite edges thereof and a rib defined in the central region.

15. The vertical support structure of claim 1, further comprising an adjuster configured to adjust the distance from the foot to the horizontal line.

16. The vertical support structure of claim 15, wherein the elongated central leg comprises a first leg portion having the head and a second leg portion having the foot, the adjuster connecting the first and second leg portions to one another.

17. The vertical support structure of claim 16, wherein the first and second leg portions each have a central region with an arm extending from opposite edges thereof and a rib defined in the central region.

18. The vertical support structure of claim 16, wherein the adjuster comprises a plurality of discrete positions defining the center line height at a plurality of different heights.

19. The vertical support structure of claim 18, wherein the adjuster comprises, on the first leg portion, a set of protrusions extending therefrom and a threaded opening between the set of protrusions, and
wherein the adjuster comprises, on the second leg portion at each of the plurality of discrete positions, a set of indentations with a keyhole opening between the set of indentations.

20. A method of supporting a junction box in a wall, comprising
installing a horizontal bottom plate on a floor;
selecting a vertical support structure having a first leg engaged with a second leg by a height adjuster;
securing a foot depending from the second leg to the horizontal bottom plate;
securing the junction box to an upper connector and a lower connector defined on a head of the first leg, the head being on an opposite end of the vertical support structure from the foot; and
using the height adjuster to adjust the first and second legs with respect to each other so that a center line height of the junction box is at a desired height, the center line height being defined by a distance from the foot to a horizontal line through the head at a point between the upper and lower connectors.
